(19) United States
(12) Patent Application Publication
(10) Pub. No.: US 2019/0155465 A1
(43) Pub. Date: May 23, 2019

(54) AUGMENTED MEDIA

(71) Applicant: String Limited, Surrey (GB)

(72) Inventor: Alan Maxwell, Newmarket, Suffolk (GB)

(21) Appl. No.: 16/097,510

(22) PCT Filed: Apr. 28, 2017
(86) PCT No.: PCT/GB2017/051206

§ 371 Date: Oct. 29, 2018

(30) Foreign Application Priority Data
Apr. 29, 2016 (GB) 1607575.6

(51) Int. Cl. G06F 3/0484; G06F 16/44; G06F 16/41; G06F 3/0481; G06T 19/00

(52) U.S. Cl. CPC G06F 3/0484; G06F 16/44; G06F 16/41; G06K 9/00664; G06T 19/006; G06F 3/04842; G06F 3/04815

(57) ABSTRACT

A method for sharing content comprising: at a data store: storing media; storing interaction data for a first user, wherein the interaction data indicates interactions of the first user with the media in relation to augmentation of the media at a first device; and in response to a request from a second device, sending the stored media and interaction data for the first user to the second device so as to enable the second device to playback the interactions of the first user with the media.

This invention relates to augmented media.

Due to the increasing capabilities of multimedia equipment (such as smartphones), augmented reality (AR) applications are rapidly expanding. These AR applications allow enrichment of a real scene with additional content, which may be displayed to a user in the form of a graphical layer overlaying a live, real-world view. Examples of augmented reality content may include two-dimensional graphics or three-dimensional representation that can be combined with a real-world view or object so as to augment that view or object with virtual content. The augmentation is conventionally presented in a way that can vary in real-time and in semantic context with environmental elements, such as information about a user's current location.

Meanwhile, there is currently a fast expansion in the sharing of media, such as video and audio, often referred to as content or digital content, over networks such as the internet. It may be desirable for users to also share augmented media. However, doing so poses a number of challenges. For example, the augmented media should be captured efficiently and accurately, shared in an efficient manner and preferably in a way that allows users to playback and interact with the augmented media. The information associated with augmented media should also be effectively managed.

According to one a first aspect there is provided a method for sharing content comprising: at a data store: storing media; storing interaction data for a first user, wherein the interaction data indicates interactions of the first user with the media in relation to augmentation of the media at a first device; and in response to a request from a second device, sending the stored media and interaction data for the first user to the second device so as to enable the second device to playback the interactions of the first user with the media.

According to a second aspect there is provided a method for playing media comprising, at a first device: receiving media and data for generating augmentations for the media; combining the media and augmentations to form augmented media; presenting the augmented media by means of the first device; recording user interactions with the augmented media; and sending the recorded user interactions to a data store.

According to a third aspect there is provided a method of playing media comprising: receiving media and interaction data indicating interactions of a first user, at a first device, with the media; at a second device, generating an augmentation for the media, the augmentation being generated in dependence on the interaction data; and combining the media and augmentation to form augmented media; presenting the augmented media by means of the second device.

According to a fourth aspect there is provided a device for sharing content comprising: a data store configured to: store media; and store interaction data for a first user, wherein the interaction data indicates interactions of the first user with the media in relation to augmentation of the media at a first device; and a communications transceiver configured to, in response to a request from a second device, send the stored media and interaction data for the first user to the second device so as to enable the second device to playback the interactions of the first user with the media.

According to a fifth aspect there is provided a device for playing media comprising: a communications transceiver configured to receive media and data for generating augmentations for the media; a processor configured to combine the media and augmentations to form augmented media; a display configured to present the augmented media; and memory configured to record user interactions with the augmented media, the communications transceiver being further configured to send the recorded user interactions to a data store.

According to a sixth aspect there is provided a device for playing media comprising: a communications transceiver configured to receive media and interaction data indicating interactions of a first user, at a source device, with the media; a processor configured to: generate an augmentation for the media, the augmentation being generated in dependence on the interaction data; and combine the media and augmentation to form augmented media; and a display configured to present the augmented media.

According to a seventh aspect there is provided a system comprising the device for sharing content described above and any of or both of the devices for playing media described above.

The present invention will now be described by way of example with reference to the accompanying drawings. In the drawings:

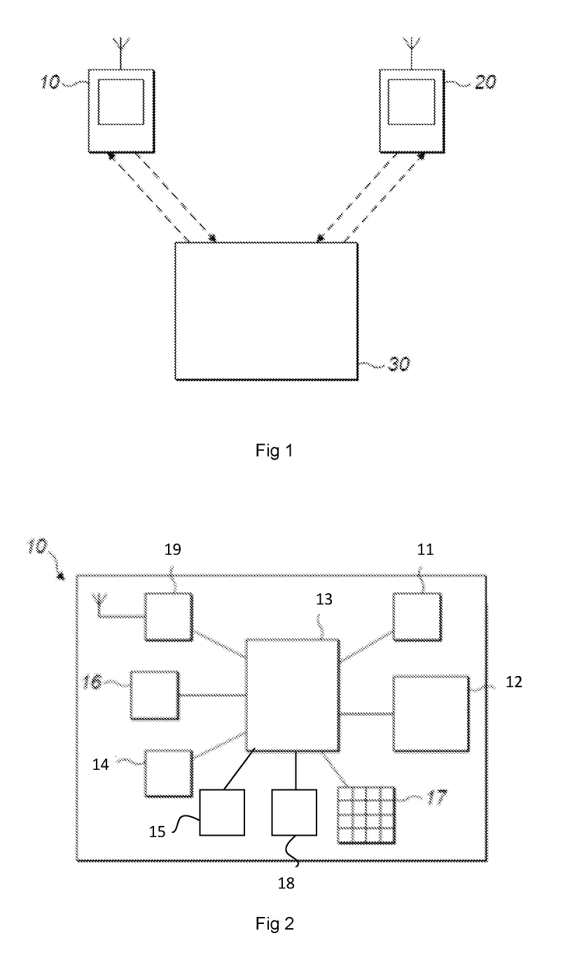

FIG. 1 shows an example of a system for generating and sharing augmented media;

FIG. 2 shows an example of a device in the system;

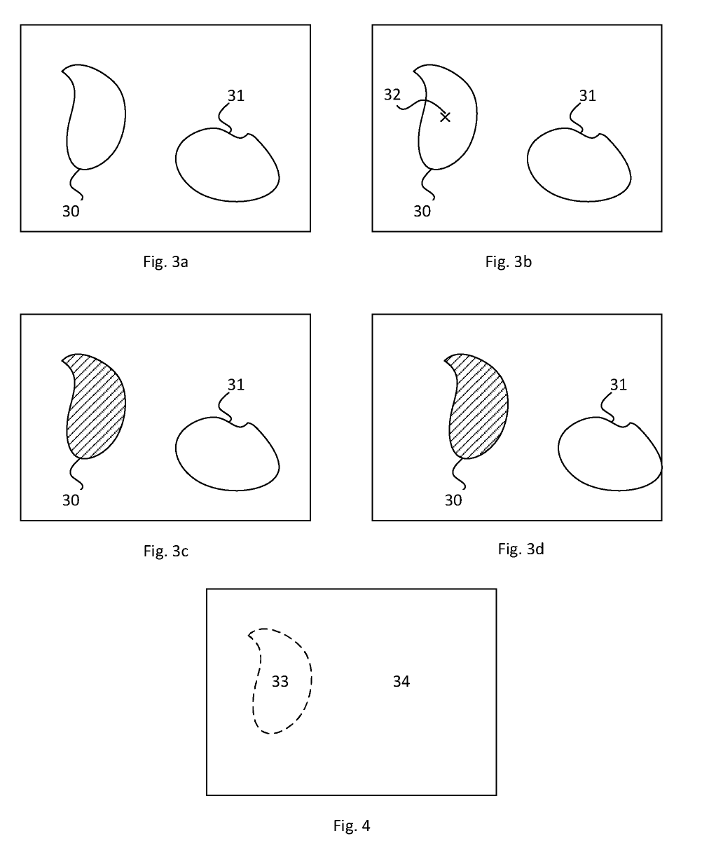

FIGS. 3a-d illustrates an example of an AR session; and

FIG. 4 shows an example of a mask.

FIG. 1 illustrates a system for enabling users to share augmented media. In this example the system is provided by first and second devices 10, 20, which are operated by first and second users respectively, and a data store 30. The data store 30 may be a server or cloud storage that is located remotely from devices 10 and 20. The data store 30 may communicate with the devices 10 and 20 over a network such as the internet. The data store 30 may comprise a wired or wireless communications transceiver for communicating with devices 10 and 20. The devices 10 and 20 could be handheld computers, smartphones, tablets, smart glasses, head-mounted displays (HMD), head-up displays (HUD), or other computing devices. The invention could be implemented using devices whose locations are mobile or fixed. The system may comprise more the two devices shown. Multiple users of the system could share a single device.

FIG. 2 illustrates an example of device 10 in more detail. In some cases, device 20 may be of the same structure. The device comprises a camera 11 (which may be a 2D, 3D or 360° camera operating within the electromagnetic spectrum), a display 12, a processor 13, a non-volatile memory or ROM 14, working memory or RAM 15 and motion sensor(s) 16 (e.g. an accelerometer and/or gyroscope) and a communications transceiver 19. The communications transceiver 19 may be a wired or wireless transceiver. The device may be powered by a battery (not shown). In this example the display 12 is a touchscreen, so it provides user input to the processor 13, but a separate user input device 17 such keypad or mouse could be provided. In another example, the display 12 may be a Head Mounted Display and the user input device 17 may be gesture control. Any suitable combination of display and user input technology could be provided. The device may comprise a storage medium 18 such as flash memory. The ROM 14 stores program code that is executable by the processor. The program code is stored in a non-transient form. The program code is executable by the processor to perform the functions described below. In operation the processor can receive an image, either from the camera 11 or from a communications transceiver 19. In the former case, the image could be an image captured by the camera of the environment at the location of the device. In the latter case, the image could be downloaded from the internet. The image could be a frame in a stream of frames from camera 11. The image could be displayed on the display 12. The processor stores the image in RAM 15. Once the image is stored in RAM, the processor can analyse and process it to augment it as described below.

One of the devices in the system of FIG. 1, e.g. device 10, may be considered to be a source device which generates content for sharing with other devices. Other devices in the system, e.g. device 20, may be considered to be consumer devices which retrieve and playback the content. The content may be generated during an AR session at the source device 10.

The source device 10 may capture media during the AR session. The generated content may comprise the captured media. The media could be, for example, a real-world image, 2D video, 3D video or 360° video captured by the camera of device 10. The media could also be a representation of a 3D virtual environment that may be generated or received by device 10.

The source device 10 may generate augmentations for the media during the AR session. The source device 10 may capture the augmentations during the AR session. The content may comprise the captured augmentations. An augmentation may be, for example, a computer-generated 2D or 3D object, a visual effect, an image, text or video that is combined with the media and displayed at the source device 10. The source device 10 may capture the augmentations separately to but in synchronisation with the captured media.

The augmentations may be generated by analysing the media and generating an augmentation as a result of that analysis. For example, an image may be analysed to detect objects (e.g. using a known object recognition algorithm) and in response to that detection generate a predetermined augmentation for that object. In some cases, the generation of an augmentation may rely on a user input. For example, an image could be analysed to detect borders (e.g. using a known border detection algorithm) and re-colour regions inside one or more detected borders in response to selection of those regions by a user by means of a user input device (such as a touchscreen). The augmentation may also rely on other inputs such as inputs from sensors at the device. For example, an augmented object may be tracked as the camera of device 10 moves using measurements from motion sensors 16 at device 10 and/or utilising visual odometry techniques.

The first user may interact with the media and augmentations during the AR session at the source device 10. The first user's interactions during the AR session may be captured. The content may comprise the captured interactions of the first user. The captured interactions may include a record of how the first user may have manipulated a computer-generated object by, e.g., changing the appearance of that object. The captured interactions may include a record of the inputs made by the first user at a user input device during the AR session. The captured interaction data may include an indication of user inputs such as inputs at the touchscreen, which may be gestures such as a tap, swipe, drag, flick, tap and hold, pinch, spread, etc. and pressure applied to the touchscreen. The location of the input at the touchscreen may also be captured. The input location may correspond to a location in the displayed media in 2D screen space a location in 3D space. Other examples of user inputs captured include pressing of buttons, voice commands, gestures (sensed, e.g. via a front-facing camera on a smartphone or a camera array on a HMD), etc.

As mentioned above, device 10 may comprise sensors such as motion sensors. These sensors may help align augmentations to positions, objects or regions in the media as a camera moves. Data from the sensors at device 10 may be captured during the AR session. The content may comprise the sensor data. The sensor data may be from motion sensors such as an accelerometer, gyroscope or any other sensor that can measure the movement of device 10 (e.g. a GPS sensor or a camera sensor in the case of visual odometry).

As mentioned above, when generating augmentations, the media may be analysed in certain ways. For example, the media may be analysed to detect borders using a border detection algorithm, recognise objects using an object recognition algorithm, detect faces using a facial recognition algorithm, etc. Device 10 may capture the results of any such analysis performed on the media. The content may comprise the captured results. For example, device 10 may analyse the media to detect objects. The objects that are detected during the AR session may be recorded. This record may form part of the content.

The data captured during the AR session at the source device 10 may be synchronised so that the media, augmentations and user interactions made during the session may be replayed at a consumer device 20. Thus, the second user at device 20 may see the AR session as it would have been seen by the first user at device 10. For example, when capturing video, each frame for the video may be associated with a timestamp or sequence order which provides a time reference for when that frame should be played out in relation to the other captured frames. The captured data, such as the user input and/or motion data may also be associated with the frame at which the user input and/or motion occurred. This association may be made, for example, by associating the user input or motion data with a timestamp or sequence number corresponding to the timestamp of the relevant video frame. By associating the user input or motion data with the video frames in this way, it is possible to determine when the inputs and motion occurred at device 10 in relation to the video.

The source device 10 may capture information about certain properties of the device. For example, the source device 10 may capture information about the camera 11 such as its field-of-view, white balance, exposure, etc. during the AR session. Other information about the device which could be captured could be properties of the display, such as its resolution, brightness, colour range, etc. This information may be used by a consumer device to process the captured augmented media so that it presents the media as it appeared to the first user. For example, the displays at the source and consumer devices may have different colour calibrations and so the consumer device may use the captured colour calibration information about the source device to translate the captured colour data for the media or augmentation into a colour that would make the media or augmentation look as it would have looked when it was displayed at the source device.

The captured content may be recorded and stored so that it can be played back at a later time. For example, the content may be stored at storage medium 18 at the source device 10 and then uploaded later to data store 30 via communications transceiver 19. Alternatively, or additionally, the content may be streamed live to data store 30 via communications transceiver 19 for storage at the data store 30. The data store 30 may receive the content and store it. A consumer device, e.g. device 20 may access data store 30 to retrieve some or all of the content for playback at device 20. For example, consumer device 20 may send a request to an entity managing the data store 30 for access to the content so that it can be downloaded. The managing entity may maintain a record of accesses to the content (e.g. at the data store 30).

In another example, device 10 may live-stream the content to device 20 so that the media and augmentations are displayed at devices 10 and 20 substantially simultaneously.

In one example, device 20 may download the content and play back the media and the augmentations as they appeared at device 10 whilst being created. This allows the second user to see how the first user interacted with the augmented media. In another example, device 20 may download certain aspects of the content which allows device 20 to generate its own augmentations. In this example, device 20 may download the media only and the second user may select their own augmentations for that media. In another example, the device 20 may download media, which may be video, and motion sensor data only and second user may generate their own augmentations for that video, which may be kept in alignment with the video as the scene moves using the motion sensor data.

Each consumer device may download some or all of the content depending on the capabilities of that device. For example, a first consumer device may have computer vision capabilities and so it is able to recognise objects in the media. Thus, this consumer device may not need to download any object recognition results for the media that was generated at and captured by source device 10 as it will be able to recognise objects itself. A second consumer device may not have any computer vision capabilities and so is unable to recognise any objects in the media. Thus, the second consumer device may download the media and the object recognition results for that media to enable it to augment that media.

The content uploaded to the data store 30 may be stored as a single entity or multiple entities, for example, as a binary large object (blob), a media file (such as MPEG4, JPEG, etc.) and associated metadata file(s), or any combination of such artefacts. The data files for the content may be linked together with a unique ID for the content. This could be referred to as the content payload. A consumer device 20 may download some or all of the content. A second user at the consumer device 20 may edit the content in its own AR session. For example, the second user may edit the content by interacting with the augmented media. The consumer device 20 may upload the edited content to the data store 30. The edited content may be stored as part of the blob for the original content. The consumer device 20 may only upload aspects of the content that are different to the original content. The upload by the consumer device may be tagged or associated with the second user. A third user at a third consumer device (not shown) may download parts of the original content uploaded by the source device 10 and the edits uploaded by consumer device 20 and combine the original and edited content to replay the AR session of the second user at the third consumer device.

FIGS. 3a-d illustrates an example of an AR session at source device 10. This session may be captured as described above to generate content. The AR session in this example relates to altering the appearance of objects in a live real-world view captured by camera 11 and displayed at display 12. Device 10 is capable of processing the live video in real-time to provide an augmented view to the first user.

FIG. 3a is a live video frame at time t0 and shows objects 30 and 31.

FIG. 3b shows a frame at some later time, t1, where a user has selected a location 32 on the display (e.g. by tapping that part of a touch screen display). The user selection may be captured as described above. Selecting a location may indicate that the user wishes to select an object at that location. The user selection may initiate an algorithm for detecting objects in the vicinity of the user selection. The algorithm may detect object 30, which is in the vicinity of the user selection point 32. The algorithm may trace out the perimeter of the object 30. The detection of the object 30 may be captured as a mask for that frame. In this example the mask may be a set of borders which define regions within the frame, but in more complex examples the mask may take other forms, as will be discussed in more detail below. For example, FIG. 4 illustrates a mask that has been generated for the frame of FIG. 3b. The mask indicates two regions 33 and 34. Region 33 corresponds to an area within the perimeter of detected object 30 and region 34 corresponds to an area outside of the detected object 30.

The selection of object 30 may be remembered for subsequent frames. In one example, object 30 may be tracked as the camera moves using known video tracking algorithms. In another example, rather than tracking object 30, selected location 32 may be tracked. Location 32 in 2D screen space may be projected out into 3D space and the location in 3D space may be tracked using motion sensors at device 10. The 2D to 3D projection may be estimated and performed using known techniques leveraging monocular depth cues, stereo cameras etc. and/or be accurately measured with a depth sensing camera. Thus, for example, if device 10 moves such that location 32 is no longer in view, that location is not lost because it is being tracked in 3D space using data from the motion or other sensors. When the device moves back within view of location 32, the object detection algorithm may be initiated again for the 2D screen space location corresponding to the projected 3D space location to re-detect selected object 30. This way, selected object 30 may be tracked even if it goes out of view due to movement of the camera.

At time t2, the user may select, e.g. from a menu, an augmentation for object 30. This may be, for example, a re-colouring of object 30 to a selected colour (e.g. red). Region 33 of the mask corresponds to object 30 and this region is coloured to the selected colour (e.g. with a predefined level of transparency). The mask is overlaid on the live video frame to provide the augmentation. This is illustrated in FIG. 3c.

The generated mask may be captured separately to the selection of the colour. For example, the captured data representing the mask may indicate the video frame that the mask corresponds to and the locations of each region in the screen space of that frame.

The captured data representing the colour selection may indicate the video frame that the colour selection is for, and which region of the mask that the selection is for. Any augmentations for regions in the mask may be captured. This data may be referred to as mask overlay data.

FIG. 3d shows a subsequent frame at time t3 where the camera has moved slightly and so objects 30 and 31 are at different locations on the screen. As mentioned above, the selected object 30 may be tracked. Thus, for this frame, a new mask is generated with new regions corresponding to the locations within the perimeter of object 30 and locations outside of the perimeter. The colour selection for object 30 is maintained and so the region in the mask that is within the perimeter is re-coloured and overlaid on the live video to display the augmented view.

Various data about this AR session may be captured and uploaded as new content to data store 30, as mentioned above. A consumer device, e.g. 20, may retrieve this content, play it back and interact with it. The way a consumer device can playback and interact with the content may depend on the capabilities of the consumer device.

In a first example, a first consumer device may have no AR capabilities. Thus, the first consumer device may simply download a video file from store 30 that corresponds to the AR session as seen by the first user (i.e. the real-world video with the re-colouring augmentation as shown in FIGS. 3a-d).

In a second example, a second consumer device may have limited AR capabilities (such as the ability to overlay an augmentation layer on media) but no computer vision capabilities. Thus, the second consumer device may download the video as captured by the camera 11, the mask generated for each frame and mask overlay data for each frame. The second consumer device may play the video and process the mask and mask overlay data for each frame of the video so that the augmentations of the source device are displayed at the consumer device. The user at the second consumer device may wish to augment the media differently to the first user. However, as the second consumer device has no computer vision capabilities, it is limited to changing the augmentations represented by the mask overlay data. For example, the user may decide to see if object 30 looks better in blue than red (the colour selected by the first user) and so the user at the second consumer device selects the object 30 (and thus corresponding region 33 of the mask) and selects the new blue colour. The second consumer device then changes the mask overlay data for subsequent frames to indicate that region 33 is blue instead of red. The video is then played back with object 30 coloured blue instead of red. As mentioned above, this edit of the content may be uploaded from the second consumer device to the data store 30. Only data corresponding to the edited frames may be uploaded and stored at data store 30.

In a third example, a third consumer device may have similar AR capabilities and computer vision capabilities as the source device 10. In this case, the third consumer device may download the video as captured by the camera 11, data representing the user input at the source device 10 and motion sensor data. The third consumer device may playback the AR session using the user input data. For example, when video is played back, the user input data indicates that at the frame at time t1 (FIG. 3b) the first user tapped at location 32. The third consumer device may then initiate its own algorithm for detecting objects in the vicinity of that location. The third consumer device may then project that location into 3D space as described above to track the selected location using the downloaded motion sensor data for each frame. The third consumer device may determine that the object 30 is to be coloured red from the user input data at a frame corresponding to time t2 (FIG. 3c). The third consumer device may then augment the video to colour object 30 red. In this way, the third device can playback the video and augmentations of the AR session at source device.

Additionally, since the third consumer device has similar capabilities as the source device 10, the user of the third consumer device may perform their own augmentations of the video. For example, the user of the third consumer device may wish to re-colour object 31. The user may select (e.g. via a mouse or any other user input method) a location in the vicinity of the object 31. That location in 2D screen space may be projected into 3D space to keep track of the selected location in case the camera pans out of view of object 31. In a similar manner to that described above, the location is tracked in 3D space using the downloaded motion data of device 10. The selection of the location in the vicinity of the object 31 may initiate an object detection algorithm to detect object 31. The detected object may then be recoloured as described above. For example, the third consumer device may generate a new mask and mask overlay data. The edits made by the third consumer device (such as new user inputs for location selection and colouring, new mask and mask overlay data, etc.) may be uploaded to the data store 30.

In another example, a source device may capture a wide-angle view (e.g. a 360° view) of a scene and a first user's interaction with that scene. When played back at a consumer device, a second user of the consumer device may pan around the scene with full six degrees of freedom (6DOF) rather than watching the scene from the point of view of the first user. The second user may pan around the scene by, e.g., moving their device, which is sensed by the device's movement sensors, or other tracking methods, or by user input (e.g., a drag gesture on a touchscreen). For example, in a 360° view of a room, the second user at the consumer device may initially be watching the first user's augmentation of re-colouring one of the walls in the room (for example). The second user may wish to see how that re-colouring would fit in with the rest of the room and so move their device (which is sensed by the motion sensors) to change the view of the scene (corresponding to the movement) to see the other parts of the room. The second user may interact with a part of the scene that is different to a part that the first user interacted with. For example, the second user may select a wall that is different to the wall augmented by the first user. The selection may then initiate an algorithm to recognise that wall and then allow recolouring of it, as described above.

When a user at the source device creates the original content he may have access to a temporally varying media element, such as a video captured by a camera or a pan around a virtual object. The temporally varying media element may be captured contemporaneously with the creation of the original content or may have been previously stored or defined. The source device presents the media element to the user in a time varying way, for example by playing out the video to a display of the source device or by displaying a pan around the virtual object. As the media element is being presented the user interacts with it. The user designates certain parts of the media content. In practice this may be done by the user clicking on or touching a point on the display or pointing to a part of a 3D model, the gesture being detectable using computer vision, tracking, and machine learning algorithms processing data from the device's sensor array or other input sources. The source device, or a server to which it can delegate processing tasks, then abstracts the user's designation to identify a feature in the media content to which the designation relates. This may for example be by performing image recognition to estimate an image feature that is at the designated point, or by estimating which 3D feature was pointed at. In this way, although in the real world the user's designation was of a point on a display or in a space divorced from the 3D model, the designation is linked to a feature in the time-varying media element. The system then determines a form of interaction with that feature. The interaction could be to select the feature for recolouring (e.g. in a particular colour), to delete the feature, to alter the feature, to direct another user to the feature and so on. The interaction may be implicit, e.g. by being the same as the user's last interaction, or could be specifically designated by the user in connection with this interaction. The source device then causes the following to be stored: (a) the time of the interaction relative to the timeline of the media element, (b) one or both of a definition of the designation that is such as to allow another device to identify the designated feature, or a definition of the designated feature itself (e.g. as a bit mask, edge definition set or any other suitable form of data) and (c) a definition of the interaction. Multiple such data sets may be stored together with the media element. Interactions of certain forms with the media element may cause the source device to alter the way in which it presents the media element. In one particularly useful example it alters the way in which it presents the designated feature in accordance with the type of the interaction, for example by recolouring, highlighting, hiding, overlaying or in another way. The alteration is associated with the feature, and the feature can be tracked as the media element plays out, even if it moves relative to the frame of the media, using image or object analysis algorithms. In subsequent stages of the media the alteration may thus be applied to the feature even if it is in a different location relative to the frame of the media.

At another device the media together with the interaction data listed above can be retrieved and played out in a way that allows another user to view the first user's interaction with the media. The device of the other user could present the first user's completed set of interactions with the media (e.g. with all parts that were recoloured being recoloured) or could play out the first user's interactions as they developed over time.

The second user's device permits the second user to interact with the media in a similar way, by designating features and interactions. Those may supersede or add to the first user's interactions. The second user's interactions can be stored with the media for subsequent playout by the first or another user.

One example of a use for this is in the processing of video content that has been generated by a device equipped with accelerometers. When video data is captured from a moving camera, in conjunction with data defining the movement of the camera (e.g. from accelerometers attached to the camera or other tracking methods), a subsequent user can view a version of the video in which they can pan around the captured scene and the video played out to them represents captured video not in the time order it was captured but in a way that corresponds to movements of the viewing user's device or user interface. This allows the viewing user to experience a stream that behaves as if they were themselves panning around the captured scene with full 6DOF. Information about media other than video (e.g. virtual 3D environments and objects) can be presented in a similar way. If the media has been interacted with as described above then any changed, highlighted etc. features can be presented to the viewer.

Each of the edits uploaded by the consumer devices may be saved in the same content payload as the original content payload. The data may be analysed to provide information about the users and how they interact with the content. The content itself may be shared amongst users via any number of different channels, for example messaging platforms like iMessage, WhatsApp and Facebook or social media networks and forums. How and where the content is shared and re-shared may also be captured in the same content payload. This allows tracking of the global distribution of content in addition to capturing how people interact with said content as created by users (e.g. on apps and websites). From the content payload, various other data can be derived such as sharing channels, interactions, locations, devices, etc. This may provide insight about users around the world, their social interactions, and their interactions with digitally manipulated content (for example recognised objects). These analytics may furthermore be used to measure the effectiveness of different social channels, TV campaigns, etc.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for sharing content comprising:
at a data store:
storing media;
storing interaction data for a first user, wherein the interaction data indicates interactions of the first user with the media in relation to augmentation of the media at a first device; and
in response to a request from a second device, sending the stored media and interaction data for the first user to the second device so as to enable the second device to playback the interactions of the first user with the media.

2. A method as claimed in claim 1 further comprising:
receiving interaction data for a second user indicating interactions of the second user with the media in relation to augmentation of the media at the second device; and
storing said received interaction data.

3. A method as claimed in claim 1 or 2, wherein the media and interaction data is stored as a single data object.

4. A method as claimed in claim 3, wherein the data object is a binary large object.

5. A method as claimed in claim 1 or 2, further comprising: assigning the media and interaction data an identifier so as to associate the stored interaction data with the stored media.

6. A method as claimed in any preceding claim wherein the interaction data for the first user comprises input data indicating one or more inputs made by the first user at the first device.

7. A method as claimed in any preceding claim further comprising receiving the media and interaction data from the first device, the first device being remotely located from the data store.

8. A method as claimed in any preceding claim wherein the media is a stream of frames.

9. A method as claimed in claim 8, wherein the interaction data indicates interactions of the first user in association with at least one of the frames.

10. A method as claimed in any preceding claim, further comprising storing sensor data comprising measurements from one or more sensors on the first device.

11. A method as claimed in claim 10 when dependent on claim 8 or 9, wherein the sensor data indicates the measurements in association with at least one of the frames.

12. A method as claimed in any preceding claim wherein the second device is remotely located from the data store.

13. A method as claimed in any preceding claim further comprising analysing the stored interaction data so as to determine attributes for the user(s).

14. A method as claimed in any preceding claim, further comprising generating data indicating the sending of the stored media and interaction data to the second device.

15. A method as claimed in claim 14, further comprising analysing the generated data so as to track sharing of the media and interaction data.

16. A method as claimed in claim 15, wherein the generated data further indicates a means for sharing the media and interaction data.

17. A method as claimed in any preceding claim further comprising storing data for generating augmentations for the media.

18. A method as claimed in claim 17, wherein said data for generating augmentations comprises regions identified within the media and the interaction data comprises user interactions for those identified regions.

19. A method for playing media comprising, at a first device:
receiving media and data for generating augmentations for the media;
combining the media and augmentations to form augmented media;
presenting the augmented media by means of the first device;
recording user interactions with the augmented media; and
sending the recorded user interactions to a data store.

20. A method as claimed in claim 19, wherein the recorded user interaction comprises input data indicating one or more inputs made by a user at the first device.

21. A method as claimed in claim 19 or 20, wherein the recorded user interactions comprise an indication of manipulations of the augmented media by the user.

22. A method as claimed in any of claims 19 to 21, wherein the media is a stream of frames.

23. A method as claimed in claim 22, wherein the recorded user interactions indicate interactions of the user in association with at least one of the frames.

24. A method as claimed in any of claims 19 to 23, wherein the first device is remotely located from the data store.

25. A method of playing media comprising:
receiving media and interaction data indicating interactions of a first user, at a first device, with the media;
at a second device, generating an augmentation for the media, the augmentation being generated in dependence on the interaction data; and
combining the media and augmentation to form augmented media;
presenting the augmented media by means of the second device.

26. A method as claimed in claim 25, wherein the interaction data comprises an indication of a location in the media selected by the first user, the augmentation being generated at the second device in response to the indicated location.

27. A method as claimed in claim 25 or 26, wherein the interaction data comprises a location in the 2D screen space of the media at the first device, the location being selected by the first user.

28. A method as claimed in claim 27, further comprising, at the second device, projecting the 2D screen space location into a corresponding 3D space location.

29. A method as claimed in claim 28, further comprising:
receiving motion data indicating motion of the first device as the media is being captured by the first device; and
tracking the selected location in 3D space in dependence on the motion data.

30. A method as claimed in any of claims 25 to 29, further comprising receiving AR data for generating augmentations for the media.

31. A method as claimed in claim 30, wherein the AR data comprises a region identified within the media and the interaction data comprises an indication of an augmentation selected by the first user for that region.

32. A method as claimed in any of claims 25 to 31, further comprising, at the second device, sending a request for the media to a data store, the media and interaction data being received in response to the request.

33. A device for sharing content comprising:
a data store configured to:
store media; and
store interaction data for a first user, wherein the interaction data indicates interactions of the first user with the media in relation to augmentation of the media at a first device; and
a communications transceiver configured to, in response to a request from a second device, send the stored media and interaction data for the first user to the second device so as to enable the second device to playback the interactions of the first user with the media.

34. A device for playing media comprising:
a communications transceiver configured to receive media and data for generating augmentations for the media;
a processor configured to combine the media and augmentations to form augmented media;
a display configured to present the augmented media; and
memory configured to record user interactions with the augmented media, the communications transceiver being further configured to send the recorded user interactions to a data store.

35. A device for playing media comprising:
a communications transceiver configured to receive media and interaction data indicating interactions of a first user, at a source device, with the media;
a processor configured to:
generate an augmentation for the media, the augmentation being generated in dependence on the interaction data; and
combine the media and augmentation to form augmented media; and
a display configured to present the augmented media.

36. A system comprising:
a device for sharing content as claimed in claim 33; and
a device for playing media as claimed in claim 34 and/or a device for playing media as claimed in claim 35.
